(19) United States
(12) Patent Application Publication
(10) Pub. No.: US 2006/0207662 A1
(43) Pub. Date: Sep. 21, 2006

(54) Pressure relief valve

(75) Inventor: Harry Kujawa, Houston, TX (US)

Correspondence Address: Mark R. Wisner;WISNER & ASSOCIATES, Suite 400, 1177 West Loop South, Houston, TX, 77027-9012, US

(73) Assignee: Oteco, Inc., Houston, TX (US)

(21) Appl. No.: 11/084,875

(22) Filed: Mar. 21, 2005

(51) Int. Cl. F16K 17/00

(52) U.S. Cl. 137/467

(57) ABSTRACT

A hydraulically attenuated pressure relief valve incorporating a seal retainer disposed in the valve body and a valve member that is movable in a valve body between a position in contact with a seal to close the flowway therethrough and a second position above or apart from the seal to open the flowway. The seal retainer is restrained in the valve body by a body cap and engages the seal with sufficient energy to allow use of the valve in high pressure environments with improved seal function, durability, and maintainability. The pressure relief valve is designed without internal, wetted threads, thereby eliminating the possibility of leakage through the threads and/or damage to the valve body by erosion or washout of the threads.

### BACKGROUND OF THE INVENTION

The present invention relates generally to pressure relief valves and more particularly to valves that open at a rapid rate to relieve pressure conditions that exceed specifications which then re-seal when the pressure returns to specified operating conditions such that fluid flow through the flowway in the valve body is stopped and the valve can be re-set.

Pressure relief valves are widely employed in pressurized systems to enhance safety and maintain system integrity. Typically, these valves are preset to open at a pressure approaching the system limits. Such limits may exceed 5000 psi pressures that exceed the design capability of pressure relief valves available until recently. Pressure relief valves that can operate at higher pressures must balance the pressure-generated forces on the valve member so as not to exceed design capabilities of the trip mechanism. This balancing is accomplished by the use of an additional pressure chamber above the valve member (see, for instance, U.S. Pat. No. 5,715,861). Generally, the higher the pressure, the greater the hydraulic forces in the system and thus the necessity for the valve to open quickly to relieve excess pressure and prevent failure or rupture. Proper functioning of the valve mechanism and valve pressure release, and the integrity of the valve seals, are critical concerns in such systems.

Pressure relief valves that open at a rapid rate are typically employed in systems that encounter acute or transient pressure spikes in excess of the system operating or design limits. Depending upon the application, such valves may encounter these excess pressures on only limited occasions, or with recurrent frequency. When these excess pressures are encountered, the pressure relief valve must be able to open rapidly to prevent system failure or breach. In addition, as the operating pressure of the system increases, the forces acting upon the valve components increase, which can compromise valve function as a consequence of a loss of seal integrity.

U.S. Pat. No. 5,715,861 reviews the limitations of the use of resilient materials to promote proper valve function in U.S. Pat. Nos. 2,973,776 and 2,973,777. The '861 patent states that one effect of the use of such materials in these types of valves is an unintended opening and resetting cycle. This cycle could impair proper functioning of the valve or cause it to fail, thus compromising system integrity and safety. In response to these limitations, the '861 patent incorporated a hydraulic shock absorption design in the valve body and bonnet to reduce or eliminate the potentially destructive effect of these forces on the valve.

A pressure relief valve piston or valve member exposed to system pressure will only encounter the rapid acceleration—deceleration forces discussed above during an excess pressure relief event. However, it is not only important that the pressure relief valve work properly during an excess pressure event, but also that it not leak during normal system operation. Typical pressure relief valves are constructed with seals of resilient materials positioned at the interface between the component parts of the valve to resist fluid leakage. Loss of valve integrity by rupture or other failure of a seal impairs system integrity and safety.

The above-identified '776 and '777 patents disclose the use of an annular seal ring surrounding the valve member in the closed position. No other seals around the valve member stem or bushing are indicated. Pressures around the stem when the valve opened were apparently not a significant consideration of the design, or it was assumed that those skilled in the art would realize that a seal was not necessary at such locations.

The presence of a pressurized chamber above the relief port opening member/piston when the valve is opened or closed requires an additional piston seal and stem seal in the valve shown in the '861 patent to reduce leakage of fluid from the enclosed chamber. Whereas the focus of the '861 patent is on attenuation of the initial rapid movement of the relief port opening member/piston as the piston approaches its limit of travel while minimizing rebound forces into the movement of the piston, the focus of the present invention is (1) improving seal function, durability, and maintainability and (2) eliminating the possibility of leakage through threads. The seals of such valves must withstand normal system operating pressure; failure of the seals would no longer provide an enclosed chamber and fluid would escape either through the outlet port or through the stem bushing and bonnet. The '861 design uses a stem bushing in a bonnet to define an upper surface of the enclosed chamber. Excessive pressures, or physical damage to the bonnet assembly, could deform the stem bushing at the interface with the valve body and piston stem, thereby allowing significant loss of fluid under pressure.

Additional limitations of these prior designs include the use of a threaded member to engage the seal at the lower end of the valve member or valve member head of the '861 and '777 patents and the use of the inflow line conduit to compress the lower valve member seal in the '861 patent. In addition, both the '777 and '861 patents utilize threads to rotate the conduit or nut into position to engage the seal (note that the nut can be disengaged from the body by the installer and expose the valve member seal). If the conduit or nut mating surface is damaged or otherwise does not meet the specification required for mating with the seal surface, a seal failure and possible damage to the valve member could occur. Note also that the torque used by the installer could excessively compress and damage the seal also causing failure.

It is, therefore, an object of the present invention is to provide a hydraulically cushioned pressure relief valve where fluid leakage at component interfaces is minimized.

It is a further object of the present invention to minimize fluid leakage from the pressurized chamber by the use of a design that enables the use of stronger, more durable, more easily replaceable seals within the valve body.

It is a further object of the present invention to define one or more surfaces of the enclosed chamber by incorporation of a seal retaining mechanism.

It is a further object of the present invention to provide a pressurized chamber that does not utilize the surface of a stem bushing or other component of the bonnet to define the chamber.

It is a further object of the present invention to provide a valve in which the lower valve member seal is not engaged by rotation using a screw thread, and not subject to significant rotational torque forces during installation.

It is a further object of the present invention to provide a valve in which the seals are easier to install and replace compared to known prior pressure relief valves, allowing the use of stronger, more durable seal material(s).

It is a further object of the present invention to provide a valve in which the base or sub is bolted to the body, thereby reducing or eliminating the possibility of damage to the seal and valve member during installation.

Yet another object of the present invention is to improve seal retainability and also provide ease of access for maintenance or replacement of the seals.

Other objects, and the advantages of the present invention, will be made clear to those skilled in the art by the following description of the embodiments thereof

### SUMMARY OF THE INVENTION

In accordance with the present invention, these objects are achieved by providing a hydraulically cushioned pressure release valve incorporating a seal retainer to retain and engage seals at the valve member head and valve member stem. The seal retainer also defines the interior wall of an enclosed pressurized chamber, the lower wall of the chamber being defined by the upper surface of the valve member head. The seal retainer is located and retained in the valve body by a body cap on which bonnet assembly is also located.

In another aspect of the invention, a pressure relief valve is provided comprising a valve body having an inlet and an outlet defining a passage for fluid flow therethrough and a body cap releasably engaged to the body. A valve member is disposed in the body and comprises a head with at least one fluid flow passageway therethrough for providing fluid communication between the inlet port and the enclosed chamber and a stern, the valve member being movable between a first position disposed in fluid flow-blocking relationship between the inlet and outlet of the body and a second position removed from the first position. A seal retainer is positioned in the valve body and at least partially defines an enclosed chamber. The seal retainer is retained in the body by the body cap for retaining a seal therein for sealing against the stem of the valve member; and a bonnet is attached to the cap with the stem of the valve member extending into the bonnet into engagement with means for selectively disengaging the stem to allow the valve member to move to the second position and for engaging the valve member to urge the valve member into the first position.

In another aspect of the invention, the seal at the lower end of the closed valve member is located and engaged in the body by a separate base or sub attached to the body. This base portion also provides a connection to the inlet of the flowway through the body.

In another aspect of the invention, a method is provided for relieving excess fluid pressure using a pressure relief valve in a pressurized system, the pressure relief valve comprising a valve body and a valve member movable within a flowway in the valve body from a first position closing the flowway to a second position opening the flowway when pressure exceeds a pre-selected pressure. The method comprises the steps of allowing a portion of the fluid in the flowway to pass through a passage in the head of the valve member into an enclosed chamber above the head of the valve member, retaining a seal in engagement with the outside diameter of the head of the valve member with a seal retainer, retaining the seal retainer in the valve body with a body cap attached to the valve body, the body cap bearing the force resulting from the pressure of the fluid in the enclosed chamber and the valve member bearing the force resulting from the pressure of the fluid in the flowway, and moving the valve member from the first position to the second position when fluid pressure in the flowway exceeds a pre-selected pressure.

### BRIEF DESCRIPTION OF THE DRAWINGS

FIG. 1 is a longitudinal sectional view of one embodiment of a pressure relief valve constructed in accordance with the teachings of the present invention;

FIG. 2 is a longitudinal sectional view of the pressure relief valve of FIG. 1 taken along the line A-A in FIG. 1;

FIG. 3 is a longitudinal sectional view of the pressure relief valve of FIG. 1 showing the valve member in the open position;

FIG. 4 is a longitudinal sectional view of the pressure relief valve of FIG. 1 taken along the same line as FIG. 2 showing the valve member the open position;

FIG. 5 is a longitudinal sectional view of a second embodiment of a pressure relief valve constructed in accordance with the teachings of the present invention in which the reference numbers are the same as FIGS. 1 and 2; and

FIG. 6 is a longitudinal sectional view of the pressure relief valve of FIG. 5 taken along the line A-A in FIG. 5.

### DETAILED DESCRIPTION OF THE PREFERRED EMBODIMENT

In one embodiment of a pressure relief valve constructed in accordance with the teachings of the present invention and shown in FIGS. 1-4, the valve 10 will be seen to comprise a base or sub 11 bolted or otherwise secured to the body 12, a moveable valve member 13 disposed in the body 12, a body cap 14 bolted or otherwise secured to the body 12, and a bonnet 15 bolted or otherwise secured to the body cap 14.

An advantage of the present embodiment is that the body cap 14, connected to the body by a plurality of fasteners, bears the upward force exerted by the pressure of the fluid in flowway 30 and enclosed chamber 42 (see infra) rather than the bonnet 15. Thus, the body cap can be varied in dimension and attachment configuration as forces and design specifications require. In the present embodiment, body cap 14 is attached to valve body 12 with eight bolts. Another fastener design could be studs threaded into the body 12, requiring only the removal of nuts for disassembly. In addition, use of body cap 14 in the present embodiment enables improved access to the seals located in valve body 12. Another advantage of the present embodiment is that the bonnet assembly 15 is attached to the body cap 14 and not the body 12.

The base or sub 11 having a flowway 16 therethrough, an inlet 17 to the flowway 16 formed to receive inflow, an outlet 18 therefrom formed to mate with body 12, and a flange 19. The flange 19 having an upper surface 20 in contact with a lower surface 21 of body 12. One or more passages 23 are provided through flange 19 at an approximate right angle to the flange upper surface 20 to receive a bolt 24, stud, or other securing member. Bolt 24 inserts through passage 23 and attaches to the body 12 in threaded recess 29, thus securing the base or sub 11 to the body 12 thereby causing the flange sealing member 22 to engage the flange upper surface 20 and the body lower surface 21.

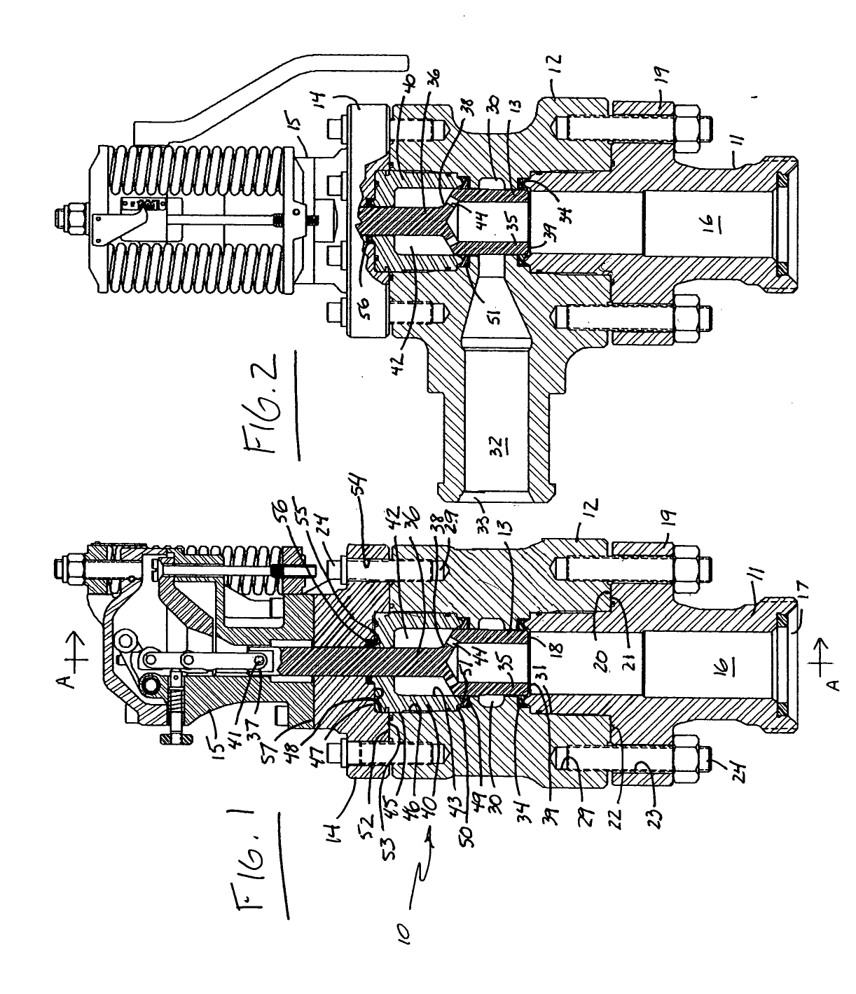

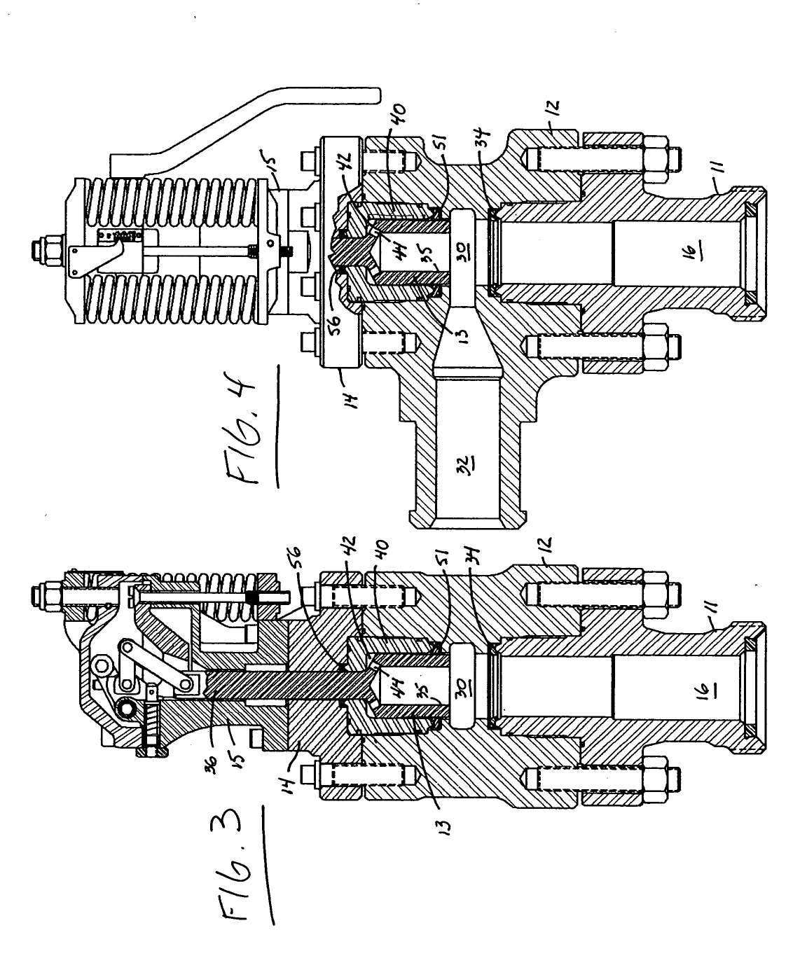

The valve body 12 having a flowway 30 comprising a base port 31 or counterbore adapted to receive base outlet 18, discharge port 32, and discharge outlet 33. A first, lower sealing member 34 is disposed in a counterbore (not numbered) formed in body 12 between base outlet 18 and body 12. A raised surface (not numbered) is formed on the outlet 18 of base/sub 11 to energize lower sealing member 34 into engagement with the outside diameter (O.D.) of the head 35 of valve member 13. Valve member 13 is movable in valve body 12 from a first, closed position in which first sealing member 34 seals against head 35 to close the flowway as shown in FIGS. 1 and 2, and a second position above or apart from first sealing member 34 to open flowway 30 as shown in FIGS. 3 and 4.

Valve member 13 has a head 35, a stem 36 extending from said head 35, a stem end 37, an upper surface 38 comprised of the difference between the O.D. of stem 36 and the O.D. of head 35, and a lower surface 39 facing flowway 16. Stem 36 extends from head 35 through a seal retainer 40 and body cap 14 to reversibly attach with a pin 41 or other attachment to bonnet 15. The upper surface 38 of head 35 is the lower wall of the enclosed chamber 42 further defined by the inner wall 43 of the seal retainer 40. One or more passages 44 are provided through the head 35 of valve member 13 to allow fluid from flowway 16 into enclosed chamber 42, thereby providing a confined fluid volume at flowway pressure. The importance of this confined fluid volume is apparent when the flowway 16 pressure exceeds the release pressure setting of the bonnet 15, at which time valve member 13 moves to the open position as shown in FIGS. 3 and 4, allowing fluid flow from base flowway 16 through body flowway 30 to the discharge port 32. As the valve member 13 moves in response to the release by the bonnet, the presence of the fluid in the confined fluid volume in the enclosed chamber 42 restricts the rate at which the valve member 13 moves since the fluid in this enclosed fluid volume must exit through passages 44 against initial flowway 16 pressure to allow the valve member to occupy the enclosed chamber 42 and open the flowway, thus absorbing and reducing the acceleration and deceleration forces encountered by valve member 13 in releasing pressure.

The seal retainer 40 is removably held in place by contact of its outer surface 45 with a counterbore 46 in the body 12, and its upper surface 47 with a counterbore 48 in the body cap 14. A raised surface 49 is formed on the seal retainer end 50. A second, middle sealing member 51 is held in place in a counterbore in body 12 by seal retainer 40, and energized by the raised surface 49 and the seal retainer end 50.

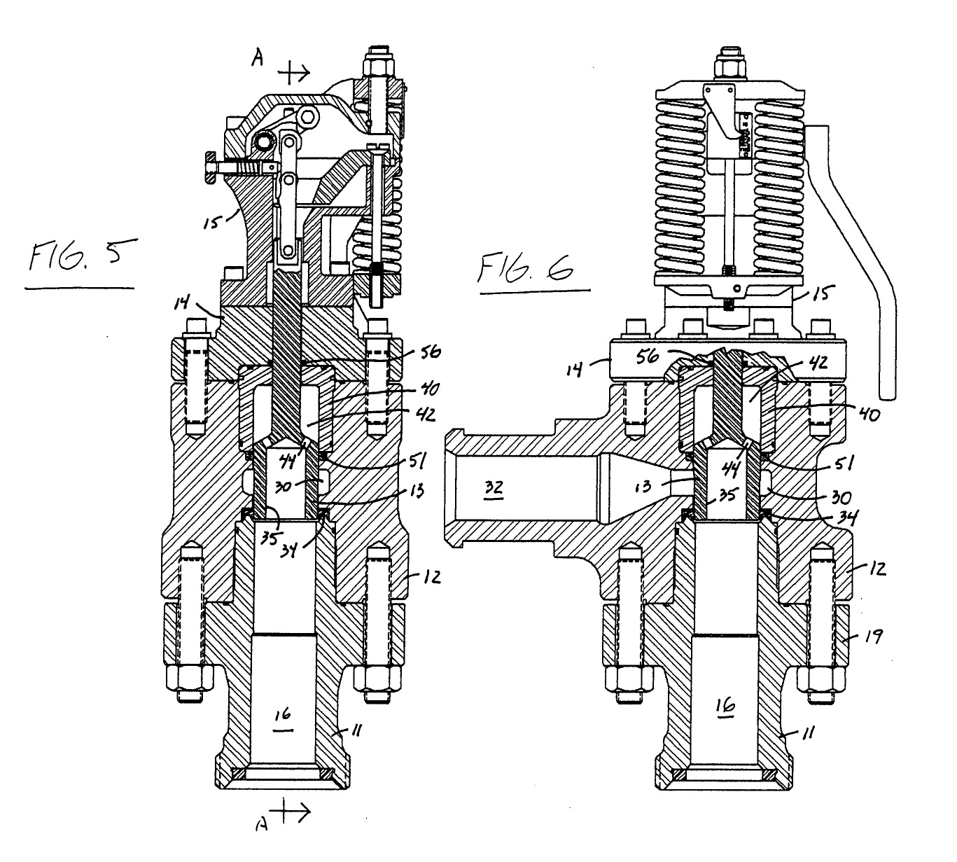

The body 12 having an upper surface 52 in contact with a lower surface 53 of body cap 14, one or more passages 54 are provided through body cap 14 at an approximate right angle to the body upper surface 52 to receive a bolt, stud, or other securing member 24. Bolt 24 inserts through said body cap passage 54 and attaches to the body 12 in recess 29, thus securing the body cap 14 to the body 12. A raised surface 55 is formed on the seal retainer 40 around the stem 36. A third, upper sealing member 56 is disposed in a counterbore (not numbered) in body cap 14 between said raised surface 55 of the seal retainer 40 and the body cap 14 and energized by said raised surface 55 to seal against stem 36 to restrict fluid leakage. The bonnet 15 may be reversibly attached to the upper surface 57 of the body cap 14 and engages the stem 36 at pin 41 to retain valve member 36 in the flowway 30. In a third embodiment shown in FIGS. 5 and 6, seal retainer 40 is formed without the raised surfaces 49 and 55, creating the opportunity to use a different type of seal between the O.D. of head 35 and the inner diameter (I.D.) of flowway 30 and the O.D. of stem 36 and the I.D. of body cap 14, respectively.

Those skilled in the art who have the benefit of this disclosure will recognize from the foregoing description of the present invention that valve 10 can be opened by backing bolts 24 out of threaded recesses 29 in body 12 so that body cap 14 and seal retainer 40 can be removed from body 12. By removing body cap 14 and seal retainer 40 in this fashion and by removing base/sub 11 from body 12 in the same fashion, the upper, middle, and lower seals 56, 51, and 34, respectively, are easily accessed, facilitating their replacement when valve 10 is refurbished. Further, because of the ease of access to upper, middle, and lower seals 56, 51, and 34, respectively, provided by the design of valve 10, it is easier to insert and seat the seals in valve 10 than it is to insert and seat the seals in conventional, known pressure relief valves. It is not uncommon, for instance, that some seals must be rolled or otherwise deformed for insertion into the valve body of conventional pressure relief valves, creating the possibility of damaging the seal, and even once inserted into the valve body of known prior pressure relief valves, it can be difficult to seat the seal in its respective seal groove. It will also be apparent to those skilled in the art who have the benefit of this disclosure that, because the seals need not be folded, rolled, or otherwise deformed in order to insert into the body 12 of the valve 10 of the present invention, it is possible to utilize seals comprised of harder materials to better withstand the pressure and/or flow of the fluid in flowway 30. In addition to known, commercially available seals, seals that may be used to advantage in connection with the valve 10 of the present invention include U-cup seals, V-spring energized seals, and so-called polyseals. Although not required, it is even possible to use metal-backed seals in connection with the valve 10 of the present invention for added durability and resistance to pressure. For these reasons, and because of the design of the pressure relief valve 10 of the present invention, the valve 10 may be advantageously used in high pressure applications.

The pressure relief valve 10 embodying the present invention also includes means incorporated in the bonnet 15 for urging the valve member 13 into the first, closed position as shown in FIGS. 1 and 2, and means for resetting valve member 13 to the first, closed position after the valve member moves to the second position out of flowway 30 shown in FIGS. 3 and 4. Such reset mechanisms are known in the art and therefore not described in detail herein.

Those skilled in the art who have the benefit of this disclosure will recognize that certain changes can be made to the component parts of the apparatus of the present invention without changing the manner in which those parts function to achieve their intended result. All such changes, and others that will be clear to those skilled in the art from this description of these embodiments of the invention, are intended to fall within the scope of the following, non-limiting claims.

What is claimed is:

1. A pressure relief valve comprising:
a valve body having an inlet and an outlet defining a passage for fluid flow therethrough;
a cap engaged to said body;
a valve member disposed in said body and comprising a head with at least one fluid flow passageway therethrough for providing fluid communication between the inlet port and the enclosed chamber and a stem, said valve member being movable between a first position disposed in fluid flow-blocking relationship between the inlet and outlet of said body and a second position removed from said first position to allow fluid to flow through the passage in said valve body;
a seal retainer positioned in said valve body and at least partially defining an enclosed chamber therein, said seal retainer being retained in said valve body by said cap and retaining a seal therein for sealing against the head of said valve member; and
a bonnet attached to said cap and having the stem of said valve member extending therein into engagement with means for selectively disengaging the stem to allow said valve member to move to said second position and for engaging said valve member to urge said valve member into said first position.

2. The pressure relief valve of claim 1 additionally comprising a lower sealing member positioned in said body in sealing relationship with said valve member.

3. The pressure relief valve of claim 1 additionally comprising an upper sealing member disposed between said seal retainer and said cap for sealing against the stem of said valve member.

4 The pressure relief valve of claim 1 wherein said cap is releasably engaged to said valve body.

5. A pressure relief valve comprising:
a body having an inlet and an outlet defining a passage for fluid flow therethrough, a counterbore, and an interior enclosed chamber;
a cap releasably engaged to said body;
a valve member disposed in said valve body and movable between a first position in fluid flow-blocking relationship between the inlet and outlet of said body and a second position in which said valve member is removed from said first position, said valve member being comprised of
a head with opposed end surfaces one of which defines a portion of said enclosed chamber,
at least one fluid flow passageway therethrough providing fluid communication between said inlet port and said enclosed chamber, and
an elongated stem extending away from said head;
a seal retainer comprising
an upper surface disposed in said cap and retained therein,
an outer surface disposed in the counterbore in said body,
an inner surface partially defining a second portion of the enclosed chamber,
an end portion, and
an internal bore in which said stem is slidably supported; and
a bonnet attached to said body cap and having the stem of said valve member disposed therein.

6. A method of relieving excess fluid pressure using a pressure relief valve in a pressurized system, the pressure relief valve being comprised of a valve body and a valve member movable within a flowway in the valve body from a first position closing the flowway to a second position opening the flowway when pressure exceeds a pre-selected pressure comprising the steps of:
allowing a portion of the fluid in the flowway to pass through a passage in the head of the valve member into an enclosed chamber above the head of the valve member;
retaining a seal in engagement with the outside diameter of the head of the valve member with a seal retainer;
retaining the seal retainer in the valve body with a body cap attached to the valve body, the body cap bearing the force resulting from the pressure of the fluid in the enclosed chamber and the valve member bearing the force resulting from the pressure of the fluid in the flowway; and
moving the valve member from the first position to the second position when fluid pressure in the flowway exceeds a pre-selected pressure.

7. The method of claim 6 additionally comprising sealing against a stem comprising a portion of the valve member, the stem extending up through the enclosed chamber and into the body cap with the seal being positioned between the seal retainer and the body cap.
